(19) United States
(12) Patent Application Publication
(10) Pub. No.: US 2026/0131750 A1
(43) Pub. Date: May 14, 2026

(54) OCCUPANT DISEMBARKATION ASSIST APPARATUS, OCCUPANT DISEMBARKATION ASSIST METHOD, AND RECORDING MEDIUM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventor: Naotsugu SHIMIZU, Tokyo (JP)

(21) Appl. No.: 19/380,592

(22) Filed: Nov. 5, 2025

(30) Foreign Application Priority Data
Nov. 8, 2024 (JP) 2024-195925

(51) Int. Cl. B60R 21/013

(52) U.S. Cl. CPC B60R 21/013

(57) ABSTRACT

An occupant disembarkation assist apparatus is provided to assist an occupant in exiting from a vehicle. The occupant disembarkation assist apparatus includes a distance determiner, a predicted time calculator, a threshold setting unit, and an operation determiner. The distance determiner determines a distance between a moving object approaching the vehicle from behind and the vehicle. The predicted time calculator calculates a predicted arrival time required until the moving object reaches the vehicle. The operation determiner determines whether an occupant disembarkation assist operation is required to be initiated depending on whether the predicted arrival time becomes lower than or equal to a time threshold. The threshold setting unit sets the time threshold as a function of the distance derived by the distance determiner. This suppresses unnecessary activation of the occupant disembarkation assist operation more efficiently than in the related art.

### CROSS REFERENCE TO RELATED DOCUMENT

The present application claims the benefit of priority of Japanese Patent Application No. 2024-195925 filed on Nov. 8, 2024, the disclosure of which is incorporated in its entirety herein by reference.

### TECHNICAL FIELD

The present disclosure relates to an occupant disembarkation assist apparatus, an occupant disembarkation assist method, and a computer-readable, non-transitory, tangible recording medium storing an occupant disembarkation assist program therein.

Japanese patent first publication No. 1990-179541 teaches a safety system working to ensure the safety of an occupant when disembarking from a vehicle (which will also be referred to below as a system-equipped vehicle). The safety system is designed as a door opening safety device for automobiles and includes a stop detector, an approaching vehicle detector, an alarm device, and a door lock mechanism. The stop detector works to detect that the system-equipped vehicle is in a stopped state. The approaching vehicle detector detects the presence of an approaching vehicle. The alarm device issues an alarm to the operator of the door when it is detected that the system-equipped vehicle is stopped, that a door opening operation is about to be initiated, and that there is an approaching vehicle. The door lock mechanism works to lock the opening of the door when the alarm is generated by the alarm device.

Specifically, the above-described door opening safety device works to calculate the distance to a following vehicle and its approaching speed using a sensor which outputs a pulse signal and receives a pulse signal arising from reflection of the outputted pulse signal on the following vehicle. The door opening safety device then calculates, from these values, an approaching time required until the following vehicle passes the system-equipped vehicle. When it is determined that this approaching time is within ten seconds, the alarm device is activated to alert an occupant who is about to open the door of the system-equipped vehicle. This causes the occupant to recognize that a vehicle is approaching the system-equipped vehicle and wait for a while before opening the door. Moreover, by not only issuing an alarm but also disabling the door opening, the safety is further improved.

The above-described type of occupant disembarkation assist device has an accuracy in calculating the distance to a moving object, such as a following vehicle, approaching from behind the system-equipped vehicle and the speed of the moving object, which usually decreases as the distance to the moving object increases. As a result, the calculation error increases at long distances from the system-equipped vehicle, leading to a risk of unnecessary activation of an occupant disembarkation assist operation, such as issuing a warning or locking the door.

### SUMMARY

This disclosure has been made in view of the above problems. It is an object of this disclosure to provide techniques for minimizing the risk of unnecessary activation of an occupant disembarkation assist operation.

According to the first aspect of this disclosure, there is provided an occupant disembarkation assist apparatus working to assist an occupant in exiting from a vehicle. The occupant disembarkation assist apparatus comprises: (a) a distance determiner that determines a distance between a moving object approaching the vehicle from behind and the vehicle; (b) a predicted time calculator that calculates a predicted arrival time required until the moving object reaches the vehicle; (c) an operation determiner that determines whether an occupant disembarkation assist operation is required to be initiated depending on whether the predicted arrival time becomes lower than or equal to a time threshold; and (d) a threshold setting unit that sets the time threshold as a function of the distance derived by the distance determiner.

According to the second aspect of this disclosure, there is provided an occupant disembarkation assist method for assisting an occupant in exiting from a vehicle. The occupant disembarkation assist method comprises: (a) a distance determining step of determining a distance between a moving object approaching the vehicle from behind and the vehicle; (b) a predicted time calculating step of calculating a predicted arrival time required until the moving object reaches the vehicle; (c) an operation determining step of determining whether an occupant disembarkation assist operation is required to be initiated depending on whether the predicted arrival time becomes lower than or equal to a time threshold; and (d) a threshold setting step of setting the time threshold as a function of the distance derived by the distance determining step.

According to the third aspect of this disclosure, there is provided a computer-readable, non-transitory, tangible recording medium storing an occupant disembarkation assist program, when executed by an occupant disembarkation assist apparatus configured to assist an occupant in exiting from a vehicle, causes the occupant disembarkation assist apparatus to perform a method comprising: (a) a distance determining step of determining a distance between a moving object approaching the vehicle from behind and the vehicle; (b) a predicted time calculating step of calculating a predicted arrival time required until the moving object reaches the vehicle; (c) an operation determining step of determining whether an occupant disembarkation assist operation is required to be initiated depending on whether the predicted arrival time becomes lower than or equal to a time threshold; and (d) a threshold setting step of setting the time threshold as a function of the distance derived by the distance determining step.

It should be noted that, in the respective sections of this application, reference numerals in parentheses may be appended to the respective elements. However, such reference numerals merely illustrate one example of the correspondence between the elements and specific means described in the embodiments set forth below. Accordingly, the present disclosure is not limited in any way by the description of the above reference numerals.

### BRIEF DESCRIPTION OF THE DRAWINGS

The present disclosure will be understood more fully from the detailed description given hereinbelow and from the accompanying drawings of the preferred embodiments, which, however, should not be taken to limit the invention to the specific embodiments but are for the purpose of explanation and understanding only.

In the drawings:

FIG. 1 is a schematic diagram illustrating a situation in which a vehicle is approaching from a right rear side of a host vehicle to which the present disclosure is applied;

FIG. 2 is a block diagram illustrating a schematic configuration of an in-vehicle system shown in FIG. 1:

FIG. 3 is a block diagram illustrating a schematic functional configuration of an occupant disembarkation assist device implemented by a controller shown in FIG. 2;

FIG. 4 is a graph illustrating an outline of setting of a time threshold by a threshold setting unit shown in FIG. 3;

FIG. 5 is a flowchart of a sequence of steps of an operation of an occupant disembarkation assist device shown in FIG. 3;

FIG. 6 is a schematic diagram illustrating an outline of an operation of an in-vehicle system according to a modified example; and

FIG. 7 is a schematic diagram illustrating an outline of an operation of an in-vehicle system according to another modified example.

### MODES FOR CARRYING OUT THE INVENTION

### First Embodiment

Embodiments according to the present disclosure will be described below with reference to the accompanying drawings. It should be noted that the embodiments, modifications thereof, and the related drawings are illustrated and simplified solely for the purpose of concisely explaining the content of the present disclosure, and the scope of the present disclosure is not limited thereby in any respect. Accordingly, it should be understood that the drawings do not necessarily correspond to the actual configuration of devices that may be manufactured and marketed. In other words, unless explicitly limited by the applicant during the course of prosecution, the present disclosure should not be construed restrictively based on the drawings or on the descriptions of the device configurations, functions, or operations set forth herein.

### Structure of In-Vehicle System

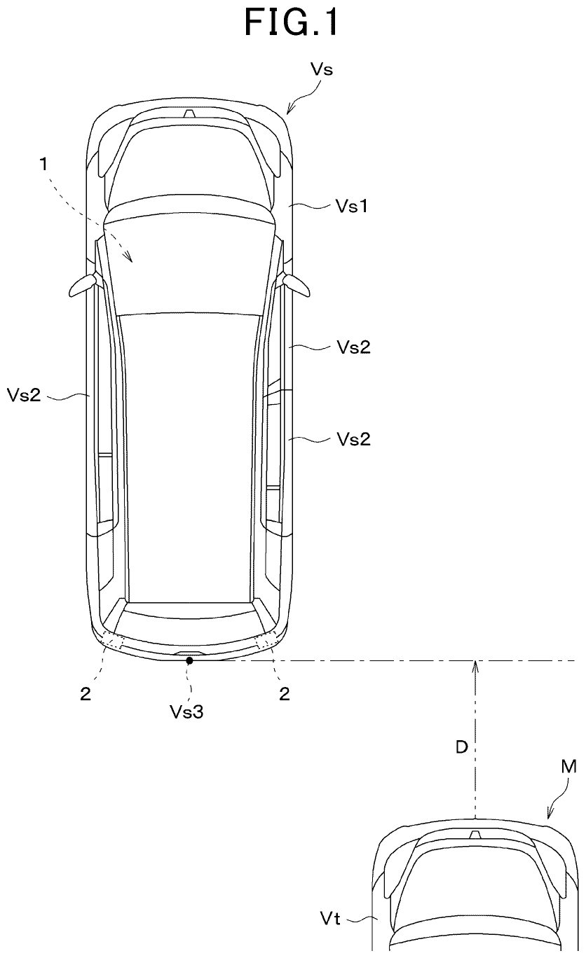

Referring first to FIG. 1, the in-vehicle system 1 is configured to be mounted on a vehicle so as to execute various operations in the vehicle. Hereinafter, the vehicle on which the in-vehicle system 1 according to the present embodiment is mounted will be referred to as the system-mounted vehicle or host vehicle Vs.

The host vehicle Vs is a so-called ordinary automobile capable of traveling on a road, and includes the vehicle body Vs1 having a box-like shape. The right and left sides of the vehicle body Vs1 have the doors Vs2. In the example shown in FIG. 1, two of the doors Vs2 are provided on the right side of the vehicle body Vs1 as swing doors, that is, hinge-type doors. In addition, one of the doors Vs2 is provided on the left side of the vehicle body Vs1 as a sliding door. However, as will be described later, the present disclosure is not limited to such a structure.

The in-vehicle system 1 is configured to execute various operations of the host vehicle Vs, including an alarm operation, using results of detection of an object around the host vehicle Vs obtained by the object sensors 2. The object sensors 2 may be, for example, a camera, a radar sensor, or the like. In the present embodiment, the in-vehicle system 1 is further configured to implement a disembarkation assist function that supports an occupant in disembarking or exiting from the host vehicle Vs. The disembarkation assist function refers to a function that, when an occupant attempts to open the door(s) Vs2, issues an alarm or inhibits the door opening operation. The inhibition of the door opening operation may include, for example, locking the doors Vs2, stopping the opening operation of a power-operated door, or otherwise prohibiting the door opening operation in the host vehicle Vs.

Specifically, the in-vehicle system 1 is equipped with two object sensors 2 at left and right corners of a rear end portion of the vehicle body Vs1, in order to detect the moving object M (for example, the vehicle Vt existing around the host vehicle Vs) approaching the host vehicle Vs from the rear or from an obliquely rear direction. When detecting the moving object M approaching the host vehicle Vs from the rear or the obliquely rear direction, the in-vehicle system 1 works to perform an occupant disembarkation assist operation according to a manner or mode in which the object M is approaching. The vehicle Vt may be not only an automobile, but also a two-wheeled vehicle such as a motorcycle, a light vehicle such as a bicycle, or a small electric vehicle such as an electric kickboard. The moving object M is not limited to the vehicle Vt and may instead be a pedestrian.

The approaching mode of the moving object M includes the approaching distance D, which is a distance between the host vehicle Vs and the moving object M. The approaching distance D is a distance, in a traveling direction of the host vehicle Vs, between the reference position Vs3 of the host vehicle Vs and the moving object M. In other words, the approaching distance D is the shortest distance between the moving object M and an imaginary straight line extending in parallel with a width direction of the host vehicle Vs from the reference position Vs3. In this embodiment, the reference position Vs3 is a rearmost position of the vehicle body Vs1.

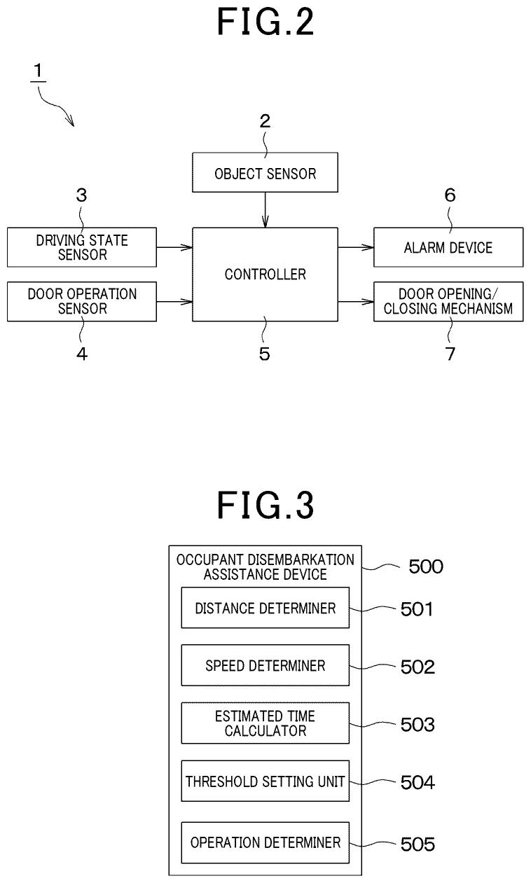

Referring to FIG. 2, the in-vehicle system 1 includes, in addition to the object sensors 2, the driving state sensor 3, the door operation sensors 4, the controller 5, the alarm device 6, and the door opening/closing mechanism 7. The object sensors 2, the driving state sensor 3, and the door operation sensors 4 are connected to the controller 5 using an in-vehicle network so that their outputs are input to the controller 5. The controller 5 is also connected to the alarm device 6 and the door opening/closing mechanism 7 through the in-vehicle network so as to be capable of transmitting and receiving information or signals.

The object sensors 2 are implemented by radar sensors configured to detect an object(a) around the host vehicle Vs using reflection of radar waves transmitted therefrom. The radar waves may be radio waves in a millimeter wave band. For simplification of illustration, the object sensors 2 are shown as a single block in FIG. 2.

The driving state sensor 3 works to obtain various parameters related to the driving state of the host vehicle Vs. The “driving state”, as referred to herein, includes a driving operation on and a driven behavior of the host vehicle Vs. The “driving operation” is a driving operation input to the host vehicle Vs made by an occupant of the host vehicle Vs (typically a driver) or by a vehicle control ECU, and includes, for example, an accelerator position, a brake position, a steering amount, a gear shift range, and the like. The ECU is an abbreviation for Electronic Control Unit. The “driven behavior” is a state relating to motion or behavior of the host vehicle Vs, and includes, for example, a vehicle speed, an acceleration, a yaw rate, and the like. That is, the driving state sensor 3 is a general term for a well-known in-vehicle sensor including an accelerator position sensor, a shift position sensor, a vehicle speed sensor, and/or a yaw rate sensor.

The door operation sensors 4 are provided one for each of the doors Vs2 of the host vehicle Vs and work to detect door opening operations on the doors Vs2 made by an occupant(a) of the host vehicle Vs. Specifically, each of the door operation sensors 4 is implemented by a touch sensor or an operating sensor which detects an operation state of a door opening member (e.g., an inside door handle) operated by the occupant(s) to open the doors Vs2 from inside the vehicle body Vs1. Each of the door operation sensors 4 generates a door operation signal and outputs it to the controller 5 when a hand of the occupant touches the door opening member or starts to operate the door opening member.

The controller 5 works to control operations of the alarm device 6 and the door opening/closing mechanism 7 in response to outputs from the object sensors 2, the driving state sensor 3, and the door operation sensors 4. The alarm device 6 may include an audio output device that generates an alarm sound or a visual output device that performs a display or light emission for alarm purposes. The door opening/closing mechanism 7 includes at least a door lock mechanism for preventing an opening operation of the doors Vs2, but may also include an electric opening/closing mechanism for electrically opening and closing the doors Vs2.

The controller 5 is configured as an in-vehicle microcomputer including a processor such as a CPU and a memory such as a ROM. The memory is a computer-readable, non-transitory, tangible recording medium, and includes a RAM and a non-volatile memory. The non-volatile memory includes at least a ROM, and may also include a non-volatile rewritable memory. The non-volatile rewritable memory is a storage device that allows information to be rewritten while power is supplied, but retains the information without permitting rewriting while power is shut off, and is, for example, a flash memory. Various data such as initial values, maps, and lookup tables necessary for executing computer programs are stored in the non-volatile memory together with the computer programs.

### Occupant Disembarkation Assist Device

The controller 5 is, as described above, capable of executing an occupant disembarkation assist operation by the processor reading and executing the computer program from the non-volatile memory. FIG. 3 shows an example of a functional block configuration of an occupant disembarkation assist device 500, which is realized by the processor included in the controller 5 shown in FIG. 2 reading and executing the occupant disembarkation assist program, which is the computer program, from the non-volatile memory.

Referring to FIG. 3, the occupant disembarkation assist device 500, which is configured to support the occupant to exist from the host vehicle Vs, has a functional configuration realized by executing the computer program, and includes the distance determiner 501, the speed determiner 502, the predicted time calculator 503, the threshold setting unit 504, and the operation determiner 505. The following describes these in order.

The distance determiner 501 works to determine the approaching distance D using an output from one of the object sensors 2, which are radar sensors. The speed determiner 502 works to determine a relative speed of the moving object M with respect to the host vehicle Vs using the output from one of the object sensors 2. The predicted time calculator 503 works to calculate an arrival time, namely a TTC, which is a time expected to be required until the moving object M reaches or collides with the host vehicle Vs. The TTC is an abbreviation for Time To Collision. The TTC, as referred to herein, is a time predicted to be required until the approaching distance D becomes zero.

The threshold setting unit 504 is configured to set a time threshold. The time threshold is a threshold for determining whether the occupant disembarkation assist operation should be started or terminated. The operation determiner 505 is configured to determine activation of the occupant disembarkation assist based on whether the TTC has become equal to or less than the time threshold.

The threshold setting unit 504 determines the time threshold as a function of the approaching distance D obtained by the distance determiner 501. Specifically, the threshold setting unit 504 sets the time threshold to be smaller when the approaching distance D is larger (i.e., when the moving object M is farther from the host vehicle Vs) than when the approaching distance D is smaller (i.e., when the moving object M is closer to the host vehicle Vs).

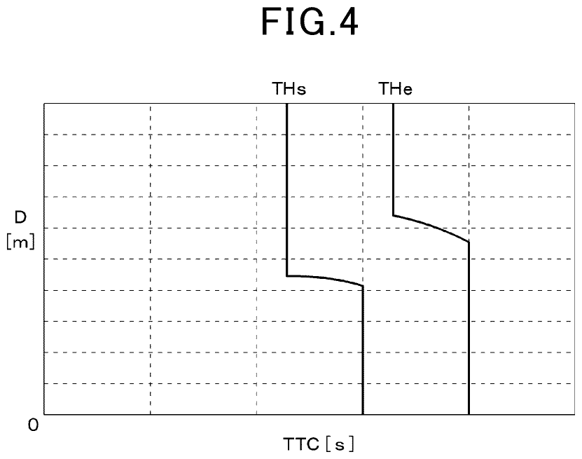

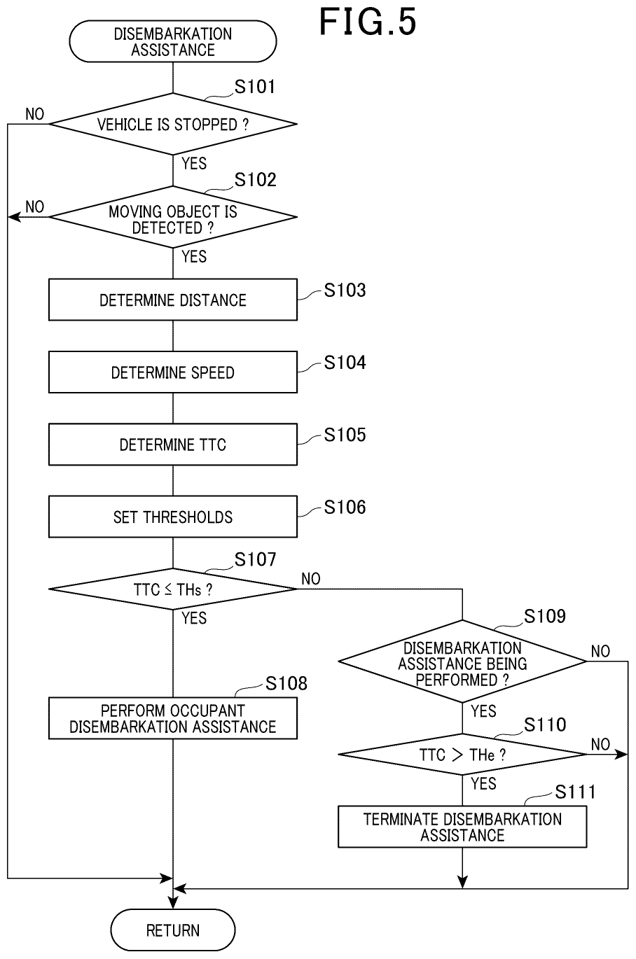

FIG. 4 is a graph which represents how to determine the time threshold. In FIG. 4, the assist start threshold THs is a time threshold for determining a start of the occupant disembarkation assist. The operation determiner 505 determines that the occupant disembarkation assist is to be started when the TTC becomes equal to or less than the assist start threshold THs from a state in which the TTC is greater than the assist start threshold THs. The assist termination threshold THe is a time threshold for determining termination of the occupant disembarkation assist. The operation determiner 505 determines that the occupant disembarkation assist should be terminated when the TTC exceeds the assist termination threshold THe. Further, in order to suppress control hunting, the assist termination threshold THe is set to a value larger than the assist start threshold THs.

As shown in FIG. 4, the assist start threshold THs is set to a smaller value in a long-distance region, that is, a region where the approaching distance D is large, than in a short-distance region, that is, a region where the approaching distance D is small. Similarly, the assist termination threshold THe is also set to a smaller value in the long-distance region where the approaching distance D is large than in the short-distance region where the approaching distance D is small. In other words, the threshold setting unit 504 determines the time threshold used for a second distance in which the approaching distance D belongs to the long-distance region to be smaller than the time threshold used for a first distance in which the approaching distance D belongs to the short-distance region. It should be noted that, as will be described later, the mode of setting the time threshold is not limited to that shown in the graph of FIG. 4.

### Operation

The operation of the occupant disembarkation assist device 500 will be described below together with effects achieved by its configuration and by methods and programs executed thereby. In the following discussion, the configuration of the occupant disembarkation assist device 500 in this embodiment as well as the methods and programs executed thereby, may also be referred to as “the present embodiment.”

The driving state sensor 3 detects the driving state of the host vehicle Vs. When the host vehicle Vs is in a stopped state-namely, when the speed of the host vehicle Vs is 0 km/h and the stopped state is maintained by braking and/or being placed in a parking gear position of the host vehicle Vs, disembarkation of the occupant(s) from the host vehicle Vs becomes possible. When such a disembarkation-permissible state is established, the controller 5 executes the occupant disembarkation assist operation in response to detection of the moving object M by the object sensors 2 and detection of an operation state of the door opening member by one of the door operation sensors 4.

FIG. 5 is a flowchart of a sequence of steps of the occupant disembarkation assist program. In the flowchart, “S” is an abbreviation for “Step.” A processor and a non-volatile memory provided in the controller 5 will be hereinafter simply referred to as “the processor” and “the non-volatile memory.” The processor reads the occupant disembarkation assist program according to the present embodiment from the non-volatile memory, and activates the program at predetermined time intervals (for example, 10 msec), thereby executing the occupant disembarkation assist method according to the present embodiment.

After entering the program in the processor, the routine proceeds to step S101 wherein it is determined whether the host vehicle Vs is stopped, i.e., in the disembarkation-permissible state. If a NO answer is obtained in step S101 meaning that the host vehicle Vs is not in the stopped state, then the routine terminates without executing operations in step S102 and the following steps. Alternatively, if a YES answer is obtained in step S101 meaning that the host vehicle Vs is in the stopped state, then the routine proceeds to step S102.

In step S102, the processor determines whether the moving object M approaching the host vehicle Vs is detected at a rear side or an obliquely rear side of the host vehicle Vs. If a NO answer is obtained in step S102 meaning that no moving object is detected, then the routine terminates without executing operations in step S103 and the following steps. Alternatively, if a YES answer is obtained, then the routine proceeds to step S103.

In step S103, the processor obtains the approaching distance D. The routine then proceeds to step S104 wherein the processor calculates the speed of the moving object M relative to the host vehicle Vs. At this time, the host vehicle Vs is in the stopped state. The relative speed is, therefore, equal to the speed at which the moving object M is traveling. The routine proceeds to step S105 wherein the TTC is calculated. The determination or calculation of the distance D, the relative speed, and the TTC may be achieved in a well-known manner. The explanation thereof in detail will be omitted here.

After step S105, the routine proceeds to step S106 wherein the assist start threshold THs and the assist termination threshold THe are determined as a function of the approaching distance D derived in step S103. The routine proceeds to step S107 wherein it is determined whether the TTC is lower than or equal to the assist start threshold THs.

If a YES answer is obtained in step S107 meaning that the TTC is less than or equal to the assist start threshold THs, then the routine proceeds to step S108 and subsequently terminates. In step S108, the occupant disembarkation assist operation is performed. If a NO answer is obtained in step S107 in the previous execution cycle of this program, and a YES answer is obtained in step S107 in this execution cycle of this program, the operation in step S108 corresponds to a start of the occupant disembarkation assist operation. Alternatively, if a NO answer is obtained in step S107 indicating that the TTC is greater than the assist start threshold THs, then the routine proceeds to step S109.

In step S109, the processor determines whether the occupant disembarkation assist operation is currently being executed. If a NO answer is obtained indicating that the occupant disembarkation assist operation is not currently being executed, then the processor skips all steps subsequent to the step 110 and temporarily terminates this routine. Alternatively, if a YES answer is obtained in step S109 indicating that the occupant disembarkation assist operation is currently being executed, then the routine proceeds to step S110.

In step S110, it is determined whether the TTC is greater than the assist termination threshold THe. If a YES answer is obtained indicating that the TTC is greater than the assist termination threshold THe, then the routine proceeds to step S111 wherein the occupant disembarkation assist operation is terminated. Alternatively, if a NO answer is obtained in step S110 indicating that the TTC is smaller than or equal to the assist termination threshold THe, then the routine terminates without performing the operation in step S111. In this case, the occupant disembarkation assist operation is kept performed.

As described above, the in-vehicle system 1 in this embodiment works to set the determination threshold used or initiating or terminating the occupant disembarkation assist operation as a function of the approaching distance D, which is a distance between the host vehicle Vs and the moving object M, such as the vehicle Vt existing around the host vehicle Vs. Specifically, the present embodiment is configured such that, as the approaching distance D becomes greater, the time threshold becomes smaller (i.e., shorter). Accordingly, it is possible to suitably suppress an unnecessary operation of the occupant disembarkation assist function caused by a decrease in detection accuracy of the approaching distance D and the relative speed of the moving object M at a long distance from the host vehicle Vs.

### Modifications

The present disclosure is not limited to the embodiment and examples described above. Therefore, appropriate modifications can be made to the above embodiment. Representative modified examples will be described below. In the following description of the modified examples, differences from the above embodiment are mainly explained. In addition, parts that are identical or equivalent between the above embodiment and the following modified examples are denoted with the same reference numerals. Accordingly, in the description of the following modified examples, with respect to components having the same reference numerals as those in the above embodiment, the explanations in the above embodiments may be appropriately referred to unless a technical inconsistency arises or a particular additional explanation is required.

The present disclosure is not limited to the specific applications or device configurations referred to in the above embodiment. For example, the host vehicle Vs may be a so-called passenger car or a large-sized vehicle. The shape and size of the vehicle body Vs1 are, however, not particularly limited. Likewise, the number and structure of the doors Vs2 are not particularly limited. Specifically, the doors Vs2 may all be swing doors, or may all be sliding doors.

The object sensors 2, which detect the moving object M located behind or diagonally behind the host vehicle Vs, are not limited to radar sensors, but may also include cameras or ultrasonic sensors. Alternatively, the detection of the moving object M may be carried out using so-called sensor fusion, in which detection results from multiple types of sensors are integrated.

All or part of the controller 5 may be configured with a digital circuit capable of implementing the above-described functions or operations, for example, a configuration including an ASIC or an FPGA. ASIC stands for Application-Specific Integrated Circuit, and FPGA stands for Field-Programmable Gate Array. Within the controller 5, an in-vehicle microcomputer and a digital circuit may coexist.

The computer program according to the present disclosure, which enables the execution of various operations, procedures, or processes described in the above embodiment, may be downloaded or upgraded via V2X communication using a communication device. V2X stands for Vehicle-to-X. Alternatively, such a computer program may be downloaded or upgraded via terminal equipment provided in a manufacturing plant, maintenance facility, dealership, or the like of the host vehicle Vs. The storage medium for such a computer program may be, for example, a memory card, an optical disk, a magnetic disk, or the like.

As described above, each of the functional configurations and processes may be realized by a dedicated computer comprising a processor and a memory programmed to execute one or more functions embodied by a computer program. Alternatively, each of the functional configurations and processes may be realized by a dedicated computer comprising a processor configured with one or more dedicated hardware logic circuits. Further, each of the functional configurations and processes may be realized by one or more dedicated computers configured with a combination of one or more processors and one or more memories programmed to execute one or more functions, together with one or more other processors configured with one or more hardware logic circuits. Furthermore, the computer program may be stored, as instructions to be executed by a computer, in a computer-readable, non-transitory, tangible storage medium. Each of the functional configurations and processes can also be expressed as a computer program including procedures for realizing the same, or as a non-transitory, tangible storage medium storing such a computer program.

The present disclosure is not limited to the specific functions or operation modes illustrated in the above embodiment. For example, the variation modes of the assist start threshold THs and the assist termination threshold THe accompanying a change in the approaching distance D are not limited to step-like forms as illustrated in FIG. 4, but may instead take other forms, such as sigmoid curves. In addition, the long-distance region and the short-distance region are not limited to being parallel with the vertical axis as illustrated in FIG. 4, but may alternatively be straight lines inclined with respect to the vertical axis.

The operations specified by the flowchart illustrated in FIG. 5 may be triggered in response to the fulfillment of a predetermined start condition, including, for example, the stopped state of the host vehicle Vs. In this case, step 101 may be omitted, since it is already included in such a start condition.

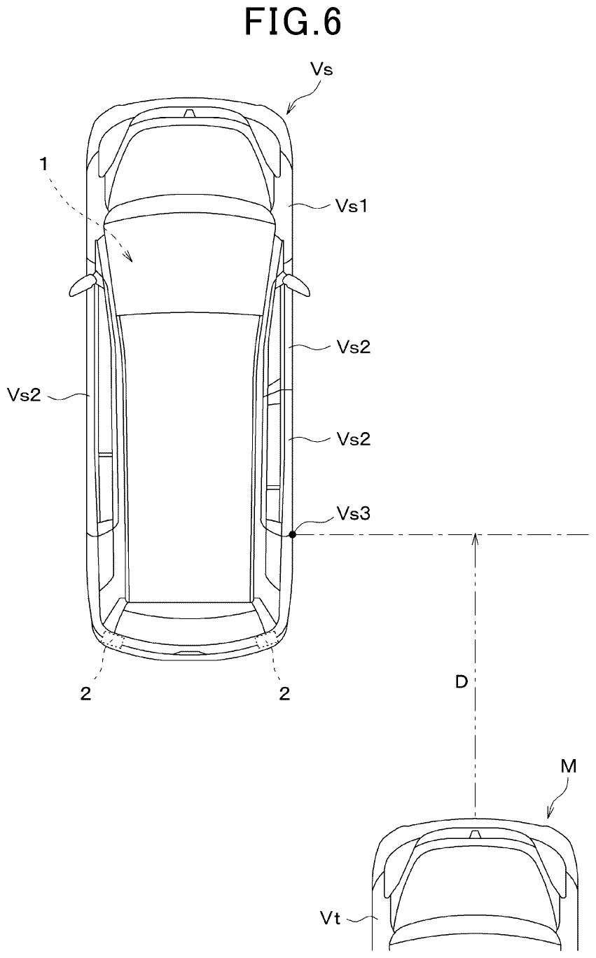

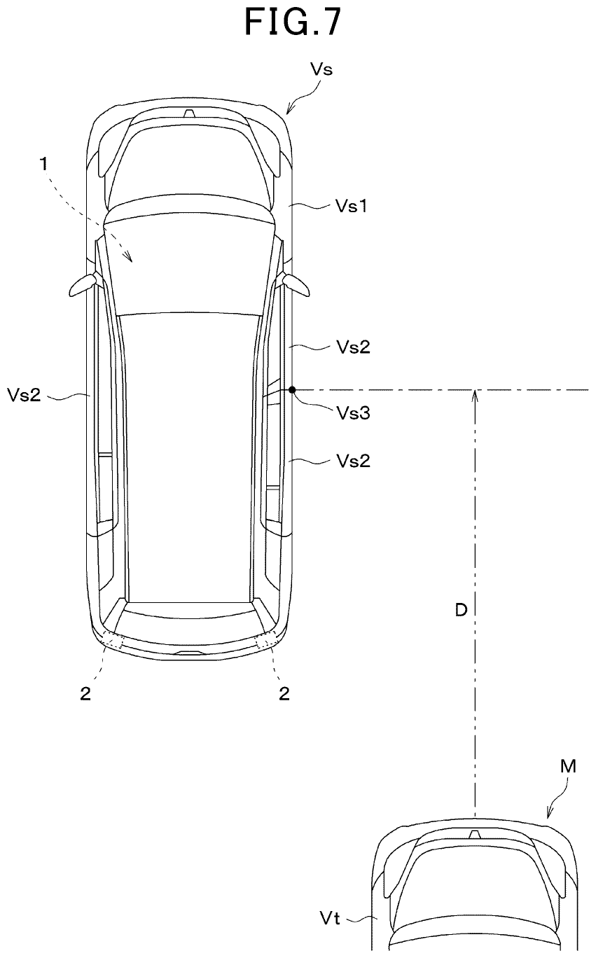

The reference position Vs3 may be set, as illustrated in FIG. 6, to the rear end of the rearmost one of the doors Vs2. Alternatively, as illustrated in FIG. 7, the reference position Vs3 may be set to the rear end of one of the doors Vs2 that an occupant of the host vehicle Vs, who requires assistance in disembarkation, is attempting to operate for opening. Such a door Vs2 may be identified using an output from a corresponding one of the door operation sensors 4. When a plurality of occupants simultaneously or substantially simultaneously attempt to operate different doors Vs2 located at different front-rear positions, the reference position Vs3 may be set to the rear end of the rearmost one of the doors Vs2.

It goes without saying that the elements constituting the above embodiment are not necessarily essential, except in cases where they are expressly indicated as essential or are considered inherently essential in principle. In addition, when reference is made to the number, numerical values, amounts, ranges, or the like of constituent elements, the present disclosure is not limited to such specific numbers, except in cases where they are expressly indicated as essential or are considered inherently limited to specific numbers in principle. Similarly, when reference is made to the shapes, directions, positional relationships, or the like of constituent elements, the present disclosure is not limited to such shapes, directions, or positional relationships, except in cases where they are expressly indicated as essential or are considered inherently limited to such specific shapes, directions, or positional relationships in principle.

Expressions such as “acquire,”, “obtain”, “determination”, “calculate,” “estimate,” “detect,” and “sense” may be appropriately substituted for one another, provided that such substitution does not result in technical inconsistency. In addition, the expressions “exceeds the threshold” and “equal to or greater than the threshold” may be appropriately substituted for one another within a range that does not cause technical inconsistency. The same applies to the expressions “less than the threshold” and “equal to or less than the threshold.”

The modifications of the embodiment are not limited to the illustrations described above. For example, all or part of one modification may be combined with all or part of another, provided that no technical inconsistency arises. Furthermore, all or part of the above specific embodiment may be combined with all or part of the above modifications, again provided that no technical inconsistency arises.

What is claimed is:

1. An occupant disembarkation assist apparatus configured to assist an occupant in exiting from a vehicle comprising:
a distance determiner that determines a distance between a moving object approaching the vehicle from behind and the vehicle;
a predicted time calculator that calculates a predicted arrival time required until the moving object reaches the vehicle;
an operation determiner that determines whether an occupant disembarkation assist operation is required to be initiated depending on whether the predicted arrival time becomes lower than or equal to a time threshold; and
a threshold setting unit that sets the time threshold as a function of the distance derived by the distance determiner.

2. The occupant disembarkation assist apparatus as set forth in claim 1, wherein the threshold setting unit sets the time threshold used when the distance is a second distance to be smaller than that used when the distance is a first distance which is shorter than the second distance.

3. The occupant disembarkation assist apparatus as set forth in claim 1, wherein the threshold setting unit works to set, as the time threshold, an assist start threshold and an assist termination threshold which is greater than the assist start threshold, and
the operation determiner works to determine that the occupant disembarkation assist operation should be started when the predicted arrival time becomes smaller than the assist start threshold and that the occupant disembarkation assist operation is determined to be terminated when the predicted arrival time becomes greater than the assist termination threshold.

4. The occupant disembarkation assist apparatus as set forth in claim 1, wherein the predicted arrival time is a time expected to be required for the moving object to reach a reference position defined on the vehicle.

5. The occupant disembarkation assist apparatus as set forth in claim 1, wherein the distance determiner uses a radar sensor to determine the distance.

6. An occupant disembarkation assist method for assisting an occupant in exiting from a vehicle comprising:
a distance determining step of determining a distance between a moving object approaching the vehicle from behind and the vehicle;
a predicted time calculating step of calculating a predicted arrival time required until the moving object reaches the vehicle;
an operation determining step of determining whether an occupant disembarkation assist operation is required to be initiated depending on whether the predicted arrival time becomes lower than or equal to a time threshold; and
a threshold setting step of setting the time threshold as a function of the distance derived by the distance determining step.

7. The occupant disembarkation assist method as set forth in claim 6, wherein the time threshold used when the distance is a second distance is set to be smaller than that used when the distance is a first distance which is shorter than the second distance.

8. The occupant disembarkation assist method as set forth in claim 6, wherein an assist start threshold and an assist termination threshold greater than the assist start threshold are set as the time threshold, and
the occupant disembarkation assist operation is determined to be started when the predicted arrival time becomes smaller than the assist start threshold, while the occupant disembarkation assist operation is determined to be terminated when the predicted arrival time becomes greater than the assist termination threshold.

9. The occupant disembarkation assist method as set forth in claim 6, wherein the predicted arrival time is a time expected to be required for the moving object to reach a reference position defined on the vehicle.

10. The occupant disembarkation assist method as set forth in claim 6, wherein a radar sensor is used to determine the distance.

11. A computer-readable, non-transitory, tangible recording medium storing an occupant disembarkation assist program, when executed by an occupant disembarkation assist apparatus configured to assist an occupant in exiting from a vehicle, causes the occupant disembarkation assist apparatus to perform a method comprising:
a distance determining step of determining a distance between a moving object approaching the vehicle from behind and the vehicle;
a predicted time calculating step of calculating a predicted arrival time required until the moving object reaches the vehicle;
an operation determining step of determining whether an occupant disembarkation assist operation is required to be initiated depending on whether the predicted arrival time becomes lower than or equal to a time threshold; and
a threshold setting step of setting the time threshold as a function of the distance derived by the distance determining step.

12. The computer-readable, non-transitory, tangible recording medium as set forth in claim 11, wherein the time threshold used when the distance is a second distance is set to be smaller than that used when the distance is a first distance which is shorter than the second distance.

13. The computer-readable, non-transitory, tangible recording medium as set forth in claim 11, wherein an assist start threshold and an assist termination threshold greater than the assist start threshold are set as the time threshold, and
the occupant disembarkation assist operation is determined to be started when the predicted arrival time becomes smaller than the assist start threshold, while the occupant disembarkation assist operation is determined to be terminated when the predicted arrival time becomes greater than the assist termination threshold.

14. The computer-readable, non-transitory, tangible recording medium as set forth in claim 11, wherein the predicted arrival time is a time expected to be required for the moving object to reach a reference position defined on the vehicle.

15. The computer-readable, non-transitory, tangible recording medium as set forth in claim 11, wherein a radar sensor is used to determine the distance.
